(19) United States
(12) Patent Application Publication
(10) Pub. No.: US 2012/0114814 A1
(43) Pub. Date: May 10, 2012

(54) METHOD OF BEVERAGE PRODUCTION, APPARATUS AND SYSTEM

(75) Inventor: Douglas A. Bippert, Marietta, GA (US)

(73) Assignee: The Coca-Cola Company, Atlanta, GA (US)

(21) Appl. No.: 12/940,265

(22) Filed: Nov. 5, 2010

(51) Int. Cl. A23L 2/52; G06F 19/00; G05D 11/02

(52) U.S. Cl. 426/231; 366/152.1; 700/103

(57) ABSTRACT

There is provided a method of regulating the formulation of a multi-component beverage comprising a beverage attribute profile, the method comprising providing a first and second component of the beverage, each component having a component attribute profile; supplying to a beverage formulation zone the first component and the second component in a desired ratio and mixing the first and second components together to provide the beverage or a precursor thereof to yield a target beverage attribute profile; responsive to a change or predicted change in at least one component attribute profile, supplying information concerning the attribute change to a data processing apparatus and calculating with respect to that change an adjustment in the ratio to reduce the deviation of one or more attributes of the beverage attribute profile from the target beverage attribute profile. A production system is also provided.

The present invention generally relates to a method of producing, and apparatus and system for producing, a beverage. In particular, but not exclusively, the present invention relates to regulating a beverage attribute profile of a multi-component beverage to be produced.

Beverage products are produced each year in vast quantities to satisfy consumer demand. Traditionally, beverage manufacturers have relied on sales made in previous years to estimate the levels necessary for the upcoming year. However, guesstimating or employing “rules of thumb” carry the risk of manufacturing to significantly offset or out of date targets. Further, such techniques do not necessarily allow the manufacturing process to be optimised in terms of utilising the raw materials to their fullest extent or in terms of maintaining a product having consistent component attribute profiles, for example taste, shelf life and costs, despite variances in the supply of the components of the product.

Beverages often contain a plurality of different components; for example a carbonated orange drink may be blended from a variety of different types of component—the blend or composition determining the overall taste, texture and other properties of the resulting drink. It, therefore, remains an important aspect of beverage production to maintain the properties of the beverage components to the extent that a consumer would fail to recognise a difference in the final product.

Consumer demand and price sensitivity are also important aspects to consider in beverage production. The volume of a beverage produced should be sufficient to meet consumer demand at a price consumers will bear.

Some of the problems and issues with existing and known beverage production methods may be due to the small number (three to four) of local experts in a given field making important decisions, which decisions can on occasion be conservative and be based on high levels of assumption and uncertainty. The experts may rely on experience and a rule of thumb which the reader will acknowledge may not always be an accurate way to apply processes consistently. Such techniques and procedures are often restricted in terms of the low level of critical data that is able to be shared among decision making parties.

It is desirable, therefore, to provide a mechanism to link consumer demand with manufacturing supply, while enhancing the efficiency of the production process so that waste of raw material is minimised and beverage attribute profile consistency is regulated and maintained.

According to a first aspect, the present invention encompasses a method of producing a multi-component beverage comprising a beverage attribute profile, the method comprising providing a first and second component of the beverage, each component having a component attribute profile; supplying to a beverage formulation zone the first component and the second component in a desired ratio and mixing the first and second components together to provide the beverage or a precursor thereof to yield a target beverage attribute profile; responsive to a change or predicted change in at least one component attribute profile, supplying information concerning the attribute change to a data processing apparatus and calculating with respect to that change an adjustment in the ratio to reduce the deviation of one or more attributes of the beverage attribute profile from the target beverage attribute profile.

The attribute profile of the beverage may be considered to be the intrinsic characteristics of the beverage. The attribute profile relates to the properties of the beverage. Similarly, the component attribute profile relates to characteristics and properties of the component of the beverage. For example, the age of the beverage may be regarded as quantifiable attribute data. Of course, quantifiable attribute data may be constituted by other information relating to the beverage.

The beverage attribute profile or the at least one component attribute profile may be selected from the cost of freight and storage of a particular component, cost of a particular component, quality of a particular component, consumer demand of a particular component, available supply of a particular component and cost of processing/blending. For example, when the freight and storage cost of a particular component is high, it may be preferred to resort to an alternative component that exhibits, for instance, similar or identical characteristics to the original component, but has lower associated costs. The cost of the overall process can in this way be reduced, thereby optimising the way in which a beverage is produced. Similarly, when the quality or available supply of a particular component is negatively affected or is predicted to be negatively affected in the future, for instance, the method involves the step of adjusting the ratio of the components to counteract such a change or predicted change so as to reduce the deviation of the beverage attribute profile from an existing or target beverage attribute profile.

Optionally or additionally, the beverage attribute profile or the at least one component attribute profile may be selected from the brix level of the beverage, flavour concentrations of the beverage, acid concentration of the beverage, colour of the beverage, taste of the beverage, texture of the beverage, amount of carbonated water content, and the level of carbonation of the water of the beverage. It is desirable for these physical properties of the beverage to be regulated and this can be achieved by supplying information concerning any attribute profile change or anticipated change to the system, for instance to a database, and then calculating how to minimise or reduce the change. In some circumstances, it may not be possible to replace a like component with a like component; in which case, a replacement component can be selected which most closely matches the necessary attribute(s) of the component to be replaced.

A component of the beverage may be considered a particular type of constituent of the beverage. Where the beverage is a carbonated orange drink, it may, for example, be orange extract originating from a particular source. In other cases, it may be the same type of constituent but having different properties; for instance, orange extract taken from two different regions and having different attributes profiles such as taste and availability.

The beverage may be selected from a whole-grain nutritional beverage, high fructose sports drink, flavoured tea, flavoured coffee, caffeine-based drink, a carbonated soft drink, a nut-based drink, a dairy-based drink, mango juice, strawberry juice, vegetable juice, berry juice, alcoholic beverage, wine, tequila drink, vodka drink, rum drink, and kvass.

Whole grain beverages offer many beneficial characteristics, including lowering cholesterol and reducing the risk of obesity and heart disease. The whole-grain beverage may include ingredients selected from condensed milk, salt, sugar, juice and other food-grade products.

The whole-grain beverage may include at least one stabiliser selected from gellan gum, carrageenan, cellulose gel, cellulose gum, pectin, modified food starch, agar, guar gum, xanthan gum, propylene glycol alginate, locust bean gum, gum arabic and combinations thereof.

The whole-grain beverage may be prepared by dispersing whole-grain flour in a product batch and processed using steam injection. The steam injection may reduce the viscosity of the mixture to produce a whole-grain beverage with enhanced stability—in that it is substantially homogeneous.

A typical whole-grain beverage composition may be constituted by 1 cup of coarsely ground oats, wheat or other grains; 2 cups of water; 1 tablespoon of almond or nut butter; 2 tablespoons of honey juice or 1 tablespoon of lemon juice; 2 bananas; ⅓ teaspoon of cinnamon; ⅓ teaspoon of ground cloves; ½ teaspoon of pure vanilla extract; and ¼ teaspoon of ground ginger. For optimal taste, the grains may be soaked in water overnight, and blended together with the remaining components the following morning.

Kvass is a fermented beverage made from black or regular rye bread. During production, it's fermentation is closely monitored to ensure the alcohol level falls within the limits set for a non-alcoholic beverage—typically, the alcohol content from fermentation is less than 1.2%.

An attribute of a component may fluctuate over time by increasing or decreasing. For example, where the attribute is the cost of a particular component, the cost may increase or decrease depending on various contributing factors such as season, availability and demand.

The target beverage attribute profile may be understood as the attribute profile that is desirable. It may be considered as the attribute profile that is “ideal” in terms of initial values. The optimal blend can be obtained by setting constraints in the system so as to arrive at the desired beverage attribute profile. There may be varying degrees of acceptability of the deviation from the target beverage attribute profile; this may, for example, be in the region of +/−5% of the target beverage attribute profile value(s).

It will be appreciated that the adjustment in the ratio may be “zero”. For instance, a beverage may consist of initial components X, Y and Z. An adjustment may be calculated such that initial component X of the beverage is replaced with a similar, but not identical, component Q having a very similar attribute profile to initial component X. However, the ratio between the components of the beverage may not change in that component X may be replaced with component Q in identical amounts, so that the ratio of components X, Y and Z is the same ratio as that of components Q, Y and Z. In such a case, the ratio change would be calculated as “zero”; however, the beverage has still been adjusted in the sense that the components of the beverage have been exchanged with the intention of maintaining a consistent beverage attribute profile.

The information acquired on the at least one component attribute profile may involve consumer intelligence gathered via sensory attributes. Both chemical and physical attributes may be measured. Brix, for example, may be measured by a refractometer, and gas chromatography may be used to detect attributes such as orange extract flavour, for example.

One or more embodiments address the problem of how to maximise the taste and quality of a blend with the currently available supply of components. It is desirable to replace a component or change the blend ratio without detriment to the quality and taste of the beverage. One or more embodiments enables long-term planning solutions and flexibility to consider new sources and suppliers of components while maintaining the consistency of the beverage product. This may be by virtue of forecasted future crop attributes, for example.

It will be readily apparent to the reader that many other attributes are also applicable which are encompassed by the embodiments described herein and variants thereof.

In one or more embodiments, the raw material and physical characteristics, costs and other attributes may be input into revenue analytics software, which may process the information and provide a predictive modelling score. This score may be used to optimise the process by purchasing raw materials that have identifiable measureable attributes. The raw materials thus purchased may be recorded and their corresponding measured component attribute profiles may be fed into a database. Various calculations can be made based on various potential scenarios, and the materials may then be selected/combined based on the target beverage attribute profile; for example a beverage having a certain quality or particular cost.

The component attribute profiles may be manually input into a database or this may be an automated procedure. The database may be in the form of a spreadsheet which stores the information.

Rather than important decisions in the production of beverages being made by a small number of experts, one or more embodiments in accordance with the present method enables a cross-functional decision making process with general managers included in key decisions. To this end, robust planning can be executed at a very detailed level based on data-driven decisions. There is also enhanced visibility such that critical data is common among relevant parties so that appropriate and informed decisions can be made.

It is often the case that major decisions can be based on experience, but the minor decisions do not always follow this rule and less than optimum decisions can, therefore, be made. As an example, it may be the case that 95% of components of a beverage are utilised in the most efficient manner, but the remaining 5% may be unusable due to guesstimation. One or more embodiments of the present method allow optimisation in the sense that substantially the final 5% would also be utilised in the most efficient manner owing to information supplied to the database on component attributes and anticipated component attributes. As a result, there is provided a decision support capability.

One or more embodiments in accordance with the method enables infrastructure planning to the effect that an attribute change of a component is recognised quickly or is predicted in advance of such change, so that it becomes possible to manage the logistics of the operation more efficiently compared with having to react to sudden changes, such as a realisation that a particular component is no longer available. By contrast, one or more embodiments in accordance with the present method recognises that there may be a shortage in supply of particular component and adjust the ratio of the components to account for this change without necessitating an entirely new product—instead the components of the beverage may be substituted with those that most closely resemble the attribute profiles of the initial components, thereby maintaining as much as possible the overall beverage attribute profile. In another example, the information may provide for an increase in supply of a component and arrangements may then be made in advance for additional storage capacity of the beverage.

The attribute profile of availability of a particular component or supply thereof may be influenced by a variety of factors, including seasonal variations in growth, natural disasters, a change in importation/export duties and changes in transport of the component.

One or more embodiments in accordance with the method thus provide a way in which to regulate the attributes of a beverage product. One or more embodiments in accordance with the method rely on information supplied to the database, which information may be considered more reliable than traditional demand forecasting because the information is acquired from a direct source in the form of the consumers that will eventually purchase the end product, rather than information based purely on previous year(s) sales figures, which can be misleading.

Supply of components can in this way be linked to consumer demand to enable quicker and more precise decisions, while optimising profitability and growth. It could be said that the method synchronises and optimises decisions involving the initial beverage components to the final beverage product. In this way, the correct product may be offered to the correct consumer at the correct time for a correct amount. Correct may be understood as meaning suitable.

One or more embodiments in accordance with the method allow the attributes of a multi-component beverage to be optimised such that raw material waste is minimised. Raw materials which may constitute the components of the beverage, for instance orange extract used to make beverage, can be selected in the correct quantities by way of the present method, thereby reducing waste. The correct quantities can be established, for example, from the information acquired from the consumers together with any predictions relating to component availability.

The beverage may include components from at least two different sources. This may include, for example, the same type of orange extract taken from different locations. Of course, in some cases, the source may be in the same geographical location for all components, but the components may originate from different types of product, such as different type of orange extract.

The first and second components may reside in separate vessels before being mixed. Regulation of the attribute profile of the beverage may be enhanced by keeping the components separate before mixing. The step of adjusting the ratio of the components is made easier by keeping the components separate so that appropriate amounts of components can be selected when required.

The vessels may include valves for allowing controlled passage of the components to the beverage formulation zone. The components may then be mixed in the desired ratios in a controlled manner to provide an accurate beverage composition.

One or more embodiments in accordance with the present invention thus allow the modelling of beverage component attributes by representing their properties and characteristics in data form.

The method may further comprise automatically adjusting said ratio to reduce said deviation.

The adjustment in the ratio may comprise replacing said first component or said second component with a third component having an attribute profile in a desired ratio to yield said target juice attribute profile.

The method may further comprise automatically recognising the availability of said third component and calculating said adjustment in dependence on said availability.

The beverage may include components from at least two different sources.

The adjustment in the ratio to reduce the deviation of one or more attributes of the juice attribute profile from the target juice attribute profile may be calculated with respect to a selected period of time. The selected period of time may be the longest possible period of time, a period of time between the present and subsequent change, a season of the year or any other time period.

The method may include the step of marketing and promoting the juice in response to sufficient existing and anticipated stock levels of the juice.

The method may be a computer implemented method and the calculating step may be executed by a data processor.

The attribute of at least one component of the juice may fluctuate over time.

There are various ways the component information may be utilised. For example, the data for a particular beverage product may be input to a central database. The data may form an optimisation plan or framework for producing a beverage from known available components. The various parameters may be continuously updated. In this way, the optimisation of the method occurs by using the existing data and combining it with the new data/information so that a new or modified optimisation plan can be generated. In such an example, the method allows the user to build on a previous model or models, rather than relying on a completely new model each time. Optionally, a user may input data for a particular plan each time there is a change or expected change in requirements for the beverage to be produced or of the components of the beverage.

Another way of optimising may include inputting all the information into a database. Then, in the event of a new scenario, the optimisation module may review the information received and acquire any missing data (in terms of previously known data) from the database before running the optimisation sequence.

The data or information on component attributes should be viewed not simply as data, but a representation of the physical components and beverage, and by representing the beverage components and beverage in terms of their key attributes, it is possible to model a simulation for optimising a beverage blend made from several beverage components.

So far as the taste attributes are concerned, the optimisation of the blended beverage can thus be seen as the optimisation of the physical sensation experienced by the consumer when consuming the blended beverage, the optimisation taking place in an electrical or virtual environment. Furthermore, other physical aspects such as availability of component beverages may also be taken into account.

Viewed from a hierarchical perspective, the blend falls within an objective constraint, such as cost per unit volume to manufacture or to the consumer.

The constraints and attribute may be considered simultaneously, for example.

There is also generally a quality constraint which is a function of a subset of the attributes, for example taste attributes.

Additionally, a constraint may be viewed as a bound on an attribute or a function of one or more attributes.

In accordance with an embodiment of the present invention, the method is directed towards regulating the formulation of a beverage having a target beverage attribute profile. The attribute profile may be viewed as a constraint in the formulation optimisation model. Optionally, the target beverage attribute profile may be subject to an overriding constraint such as total cost of the beverage blend.

The constraint or constraints may include quality and component bound constraints which enforce the quality and component bounds for finished products. Within these constraints lie attribute bounds such as taste contributing parameters which include brix level, acid-brix ratio, colour, flavour concentration and viscosity. Other constraints may include supply and demand constraints involving sourcing of raw materials. Additionally, capacity constraints may also play a factor in determining the optimisation model of a beverage; i.e how much of a blend may be produced and stored for an adequate period before sale. In this way, logistical constraints are an important consideration for the optimisation model.

There may be a 1:1 ratio between sugar content and orange extract content in a carbonated orange drink, for example.

The adjustment in the ratio to reduce the deviation of one or more attributes of the beverage attribute profile from the target beverage attribute profile may be calculated with respect to a selected period of time. The attribute profile of a component may change over time; similarly, the attribute profile of a beverage may change over time. Hence, where the beverage is a carbonated orange drink for example, it is possible that the attribute profile of a particular component changes by season. More specifically, the price of the orange extract or the bitterness may vary from season to season, and adjustments to the ratio or blend of the beverage may be necessary, for instance, to keep the cost of the beverage within an acceptable range or below a certain threshold or to keep the level of bitterness consistent over the different seasons. Such adjustments may involve replacing component(s) entirely or modifying the ratios of the existing components.

The selected period of time may be the longest possible period of time, a period of time between the present and subsequent change, a season of the year or any other time period that may be appropriate for the desired yield.

One or more embodiments in accordance with the method may include the step of marketing and promoting the beverage in response to sufficient existing and anticipated stock levels of the beverage. There is a direct link between supply and consumer demand. During periods where supply of a particular component is short or expected to be short, for instance, it may be prudent to refrain from marketing or promoting the beverage product since its supply will be affected and it may not in such circumstances be possible to meet the demands of the consumers. Conversely, when the acquired information on component attributes shows that supply will be readily available, it may be beneficial to market and promote the product thereby increasing potential sale of the product, which increase in sale can be readily met by virtue of the increased availability of components.

In one or more embodiments, the method may be a computer implemented method and the calculating step executed by a data processor.

There are various ways the method allows the component information to be utilised. For example, the data is inputted to a central database where various parameters are continuously updated. In this way, the optimisation of the method occurs by using the existing data and combining it with the new data/information so that a new optimisation plan can be generated. The method, therefore, allows the user to build on previous model, rather than relying on a completely new model each time.

Another way of optimising may include inputting all the information into a database. Then, in the event of a new scenario, the optimisation module may review the information received and acquire any missing data (in terms of previously known data) from the database before running the optimisation sequence.

The data or information on component attributes is not simply data, but a representation of the physical attributes of the beverage, and by representing the beverage in terms of its key physical attributes, it becomes possible to model a simulation to optimise a blend made from several beverages.

The method may be a computer implemented method and the calculating step may be executed by a data processor.

According to a second aspect, the present invention provides a system for regulating a multi-component beverage attribute, the system comprising means for storing a first and second component of the beverage, a beverage formulation zone for mixing the first and second component of the beverage in a desired ratio effective to yield a target beverage attribute profile, the first and second component each having a component attribute profile, wherein the system comprises data processing apparatus operable to receive information concerning a change or predicted change in at least one component attribute profile and, in response thereto, is operable to calculate with respect to that change an adjustment in the ratio to reduce the deviation of one or more attributes of the beverage attribute profile from the target beverage attribute profile.

The system may further comprise means for adjusting the beverage ratio. The means may take various forms provided they can fulfil the intended purpose of adjusting the component ratio. The means may comprise one or more pumps and valves, for instance.

The means for storing the first and second components may comprise separate vessels in the system.

The formulation zone may comprise a mixing chamber in the system. The size of the mixing chamber may be dependent on the intended production size and rate of the beverage.

According to a third aspect, the present invention provides a computer implementable method of modelling the production of a multi-component beverage comprising: representing said multi-component beverage by data values indicative of a physical attribute profile of said multi-component beverage; representing first and second components of said multi-component beverage by data values indicative of respective physical attributes of said first and second components; and deriving a combinatorial relationship between respective data values of said physical attributes of said first and second component to yield a combined attribute profile within predetermined limits of data values of said multi-component beverage attribute profile.

Representing physical attributes or characteristics, for example attributes of a beverage contributing to a taste sensation as data values, allows the production and formulation of beverages to be modelled and simulated in an electric or virtual environment. Thus, natural resources such as beverages need not be wasted in trying out formulations or manufacturing consistency.

The attributes may be taste sensation attributes.

The method may further comprise applying a constraint to deriving said combinatorial relationship.

The constraint may comprise a data value or range of data values representative of the cost of said multi-component beverage.

The constraint may comprise a further data value or range of data values representative of an available amount of said first and/or second components.

The constraint may comprise a yet further data value or range of data values representative of an amount of multi-component beverage to be produced.

The combinational relationship may comprise a ratio of said first component to said second component.

The method may further comprise providing control parameters derived from said combined attribute profile to a multi-component production system for controlling the supply of said first and second component to a formulation zone in amounts corresponding to said combinatorial relationship for mixing to form said multi-component beverage.

There is also provided a computer program comprising computer program elements operative in data processing apparatus to implement the method defined herein.

According to a fourth aspect of the present invention, there is contemplated the use of the system such as set out above and according to any of the appended system claims in regulating a multi-component beverage attribute profile.

Various embodiments of the present invention will now be described more particularly, by way of example only, with reference to the accompanying Figures; in which:

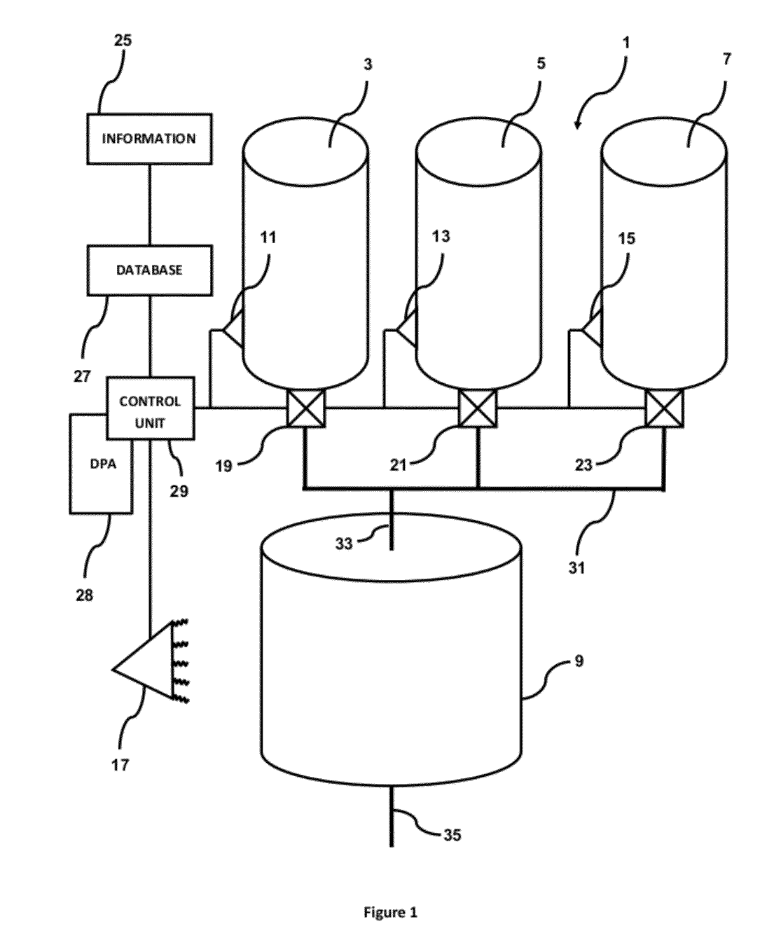

FIG. 1 is a schematic representation of a system for the production of a multi-component beverage in accordance with an embodiment of the present invention;

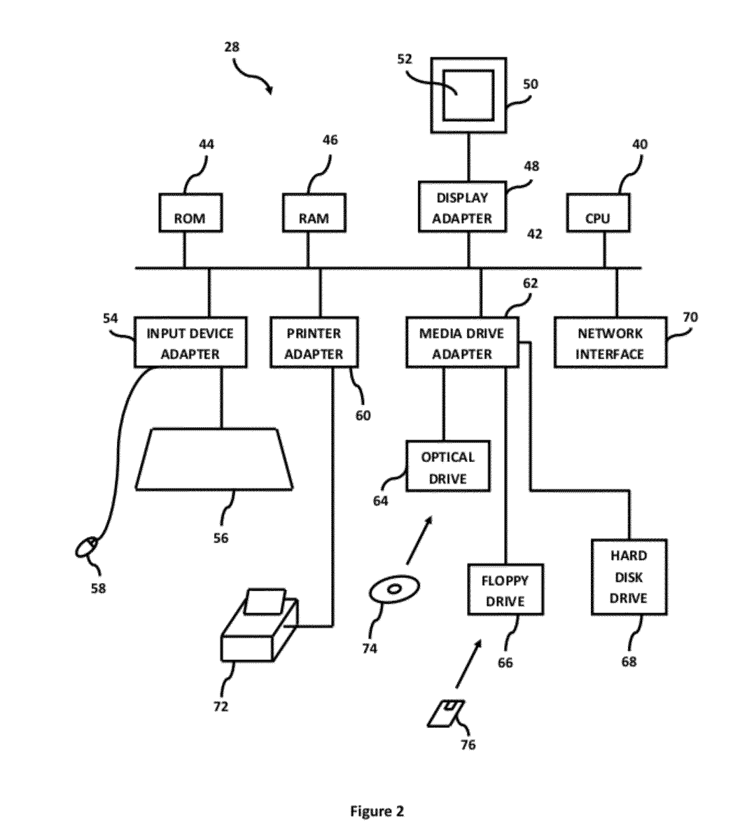

FIG. 2 is a block diagram illustrating the components of a data processing apparatus;

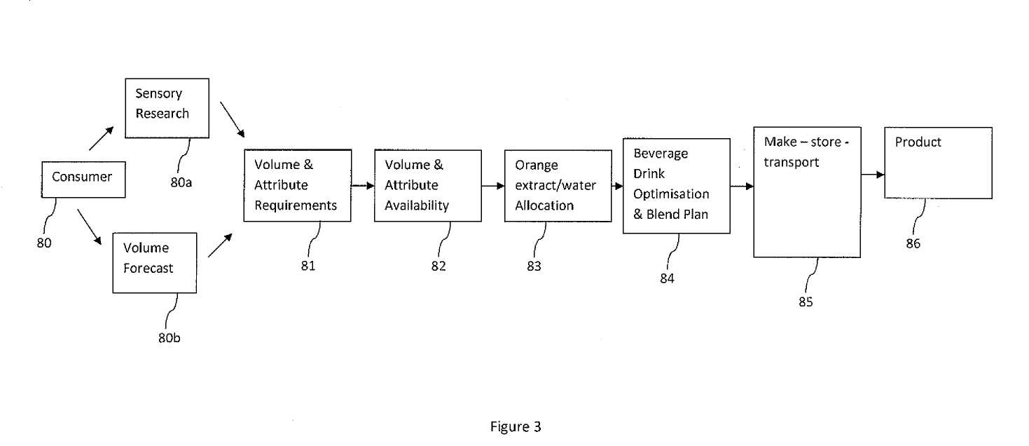

FIG. 3 is a schematic overall process flow diagram illustrating a system regulating the formulation of a multi-component beverage having a beverage attribute profile;

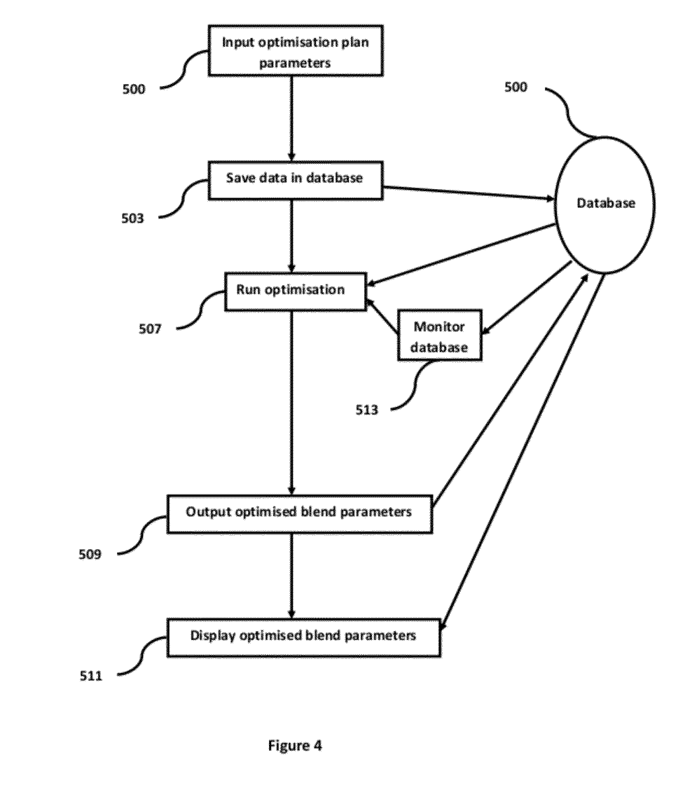

FIG. 4 is a flow diagram of the optimisation procedure in accordance with an embodiment of the present invention;

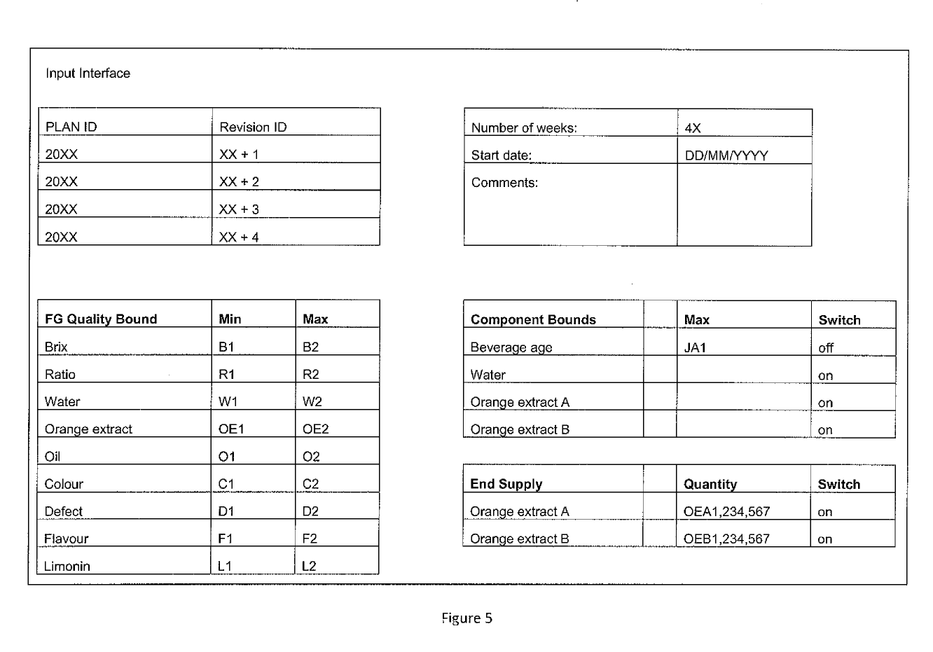

FIG. 5 is an illustration of an input interface display screen in accordance with an embodiment of the present invention;

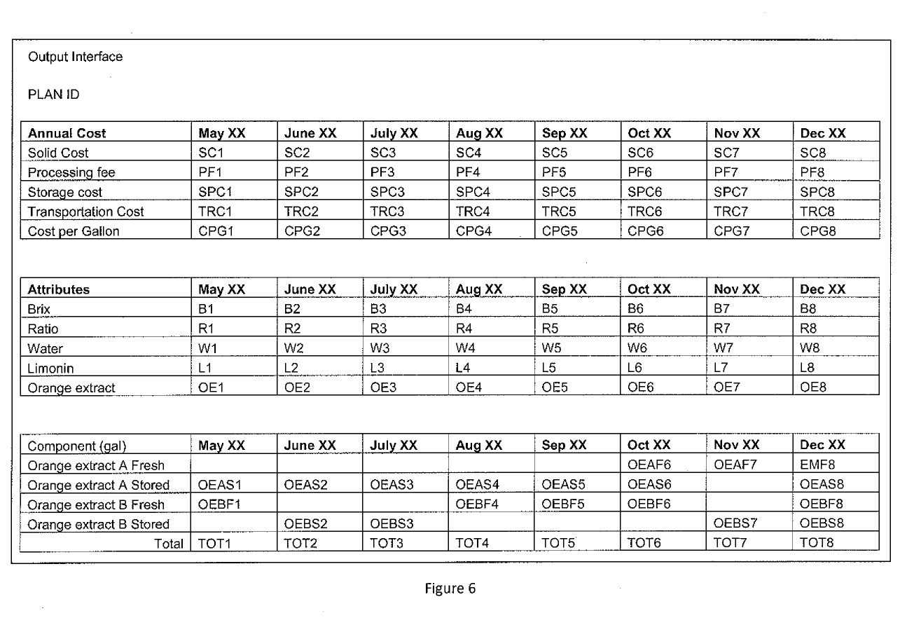

FIG. 6 is an illustration of an output interface display screen in accordance with an embodiment of the present invention;

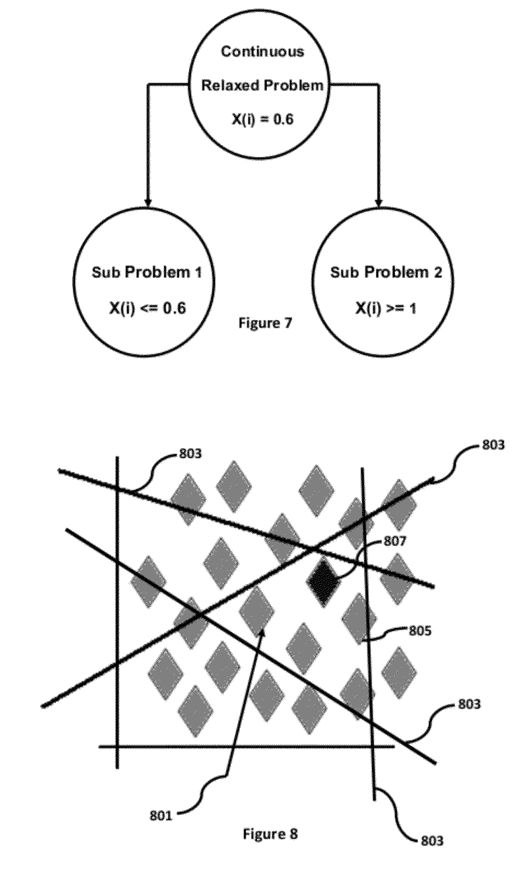

FIG. 7 is a diagram of a two dimensional linear integer program; and

FIG. 8 is a graphical representation of an interior point method model.

Referring first to FIG. 1, there is illustrated a schematic diagram of a system for the production of a multi-component beverage having a beverage attribute profile. The system is generally indicated 1.

The system 1 comprises a database 27 for storing information 25 concerning consumer preferences in terms of the measurable properties or attributes of the components including the brix level and orange extract concentration. The information 25 also includes constraints including supply, demand and cost of particular components. The system 1 also comprises three beverage component vessels 3, 5 and 7, which feed into a formulation zone constituted by a mixing chamber 9. The vessels 3, 5 and 7 and mixing chamber 9 are provided with monitoring devices 11, 13, 15 and 17 respectively. Each vessel 3, 5 and 7 is also provided with a valve 19, 21 and 23, respectively for controlling the flow of respective components to the mixing chamber 9.

In the described embodiment, the beverage component vessels 3, 5 and 7 and the mixing chamber 9 are cylindrical in shape, which aids mixing and flow therethrough.

The monitoring devices 11, 13, 15 and 17 monitor the properties of the beverage components and beverage formulation in respective vessels 3, 5 and 7 and mixing chamber 9 and supply this information to the database 27 via the control unit 29. In this embodiment, vessel 3 contains sweetened carbonated water, vessel 5 contains liquefied orange extract A and vessel 7 contains liquefied orange extract B. Measurable properties or attributes of the respective components and the carbonated orange drink include for example the brix level, orange extract concentration and acidity may be monitored. The monitoring devices 11, 13, 15 and 17 include, either integrally or remotely, analytical apparatus for performing High Performance Liquid Chromatography and Gas Chromatography (not shown).

The information corresponding to the properties or attributes represents a particular component, such as a carbonated orange drink component or a carbonated orange drink product. In this way, a physical blend may be represented by a formulation having data values representative of physical properties. Further attributes could also be monitored or derived such as the volume of beverage present, its temperature thereby delimiting the beverage in further detail. Representing physical substances as data values allows the modelling of the substance in data processing apparatus.

Information 25 acquired on consumer preferences, including taste attributes of preferred brix level, acid concentration and orange extract concentration are supplied to the database 27. Control unit 29 may include data processing apparatus 28 such as schematically illustrated in FIG. 2. Here, there is shown a schematic and simplified representation of an illustrative implementation of a data processing apparatus 28 in the form of a computer system. As shown in FIG. 2, the computer system comprises various data processing resources such as a processor (CPU) 40 coupled to a bus structure 42. Also connected to the bus structure 42 are further data processing resources such as read only memory 44 and random access memory 46. A display adapter 48 connects a display device 50, having a display screen 52, to the bus structure 42.

One or more user-input device adapters 54 connect the user-input devices, including the keyboard 56 and mouse 58 to the bus structure 42. An adapter 60 for the connection of a printer 72 is also provided. A media drive adapter 62 is provided for connecting the media drives, including the optical disk drive 64, the floppy disk drive 66 and hard disk drive 68, to the bus structure 42. A network interface 70 is provided thereby providing processing resource interface means for connecting the computer system to one or more networks or to other computer systems. The network interface 70 could include a local area network adapter, a modem and/or ISDN terminal adapter, or serial or parallel port adapter etc, as required. In this embodiment, the network interface 70 is in communication with the database 27 of FIG. 1.

It will be appreciated that FIG. 2 is a schematic representation of one possible implementation of a computer system. It will be appreciated, from the following description of embodiments of the present invention, that the computer system in which the invention could be implemented may take many forms. For example, rather than the computer system comprising a display device 50 and printer 72, it may be merely necessary for the computer system to comprise a processing unit, and be accessible to other computer systems.

A CD-ROM 74 and a floppy disk 76 are also illustrated. A computer program involving an algorithm for implementing various functions or conveying information can be supplied on media such as one or more CD-ROMs 74 and/or floppy disks 76 and then stored on a hard disk 68, for example. A program implementable by the computer system may also be supplied on a telecommunications medium, for example over a telecommunications network and/or the Internet, and embodied as an electronic signal.

The data processor 28 is configured to access consumer preference information 25 and generate an electronic representation of a desired blend formulation as data values of a target beverage attribute profile based on the consumer preferences. The target beverage attribute profile is an “ideal” profile in that it is generated, in this embodiment, without considering constraints such as cost and availability of component beverages. Thus, the target beverage attribute profile is an attribute profile of the beverage which possesses the desirable characteristics based on consumer preference information 25—in this case, the desired properties of the beverage blend that will determine its taste and mouth sensation. The target beverage attribute profile may be viewed as a beverage quality index and typically each attribute may have a range of values.

The data processor 28 is further configured to deduce the ratio of beverage components (e.g ratio of sugar to orange extract content or water to orange extract content) necessary to achieve a blend formulation having an attribute profile satisfying the target attribute profile. For example, the user can provide multiple juice components, each containing unique attributes, usage limitations (e.g., beverage component availability and timing) and costs. The data processor 28 will simultaneously consider all of these factors in determining how to match each beverage component to meet or exceed the target attribute profile for the entire production period whilst minimizing cost.

Thus, formulating a beverage blend may be controlled automatically following deduction of the beverage component ratios for satisfying the target attribute profile. Optionally, parameters representing the ratio may be displayed to a user on a display screen 52 and control unit 29 configured with those parameters by a user. The ratio can be input to the control unit 29, which in turn operates valves 19 and 21 to supply beverage components in the desired ratio to the inlet 33 of mixing chamber 9 conduits 31. Mixing occurs in the mixing chamber 9 on the principles of a continuous flow reactor. The amount of the orange extract, sugar and carbonated water in the carbonated orange drink can be controlled in real-time by adjusting the flow of the components to the mixing chamber 9 based on readings from the monitoring device 17 fed back to control unit 29. The components are mixed to yield a formulation satisfying the target beverage attribute profile.

In this and other embodiments, information 25 may include more than information concerning consumer preferences; for example, estimated product sales based on beverage component attributes, beverage component availability and cost per component of the beverage. This information may be continually updated and input to the database 27. The control unit 29 also receives current information on the attribute profile of each component from the monitoring devices 11, 13, 15 (before mixing has occurred). The control unit 29 also receives current information on the attribute profile of the formulated beverage from the monitoring device 17 (after mixing has occurred). The status of the attribute profiles of the components and the carbonated orange drink blend are, therefore, known by way of the monitoring devices 11, 13, 15 and 17. In an optional embodiment, the updated attribute profile status is input to data processing apparatus 28 which is configured to be responsive to the updated status to deduce an updated component ratio and forward the ratio to control unit 29. The control unit 29 then sends control signals to the relevant valves 19, 21 and/or 23 to adjust the flow of components to the mixer 9.

Following a change or predicted change (based on acquired information 25) in a component attribute profile, for example the reduced availability of liquefied orange extract A, the change is included in information 25 and supplied to the database 27. The data processor 28 accesses the information 25 in the database 27 and establishes whether the change or predicted change will result in an unacceptable deviation from the target beverage attribute profile. If such a deviation is identified, the data processor 28 deduces how best to counteract the deviation by generating an updated component ratio which more closely yields the target beverage attribute profile.

The data processor 28 can establish that a deviation is likely to occur due to the reduced availability of sugar. In this particular case, the data processor algorithm generates a solution to this problem; more particularly an adjusted ratio/combination of the components which would minimise the deviation owing to the reduced availability of liquefied orange extract A. In this embodiment, the data processor 28 calculates that the liquefied orange extract A of vessel 5 can be replaced by liquefied orange extract B due to similar component attributes, whereby to minimise the deviation of the target and current beverage attribute profiles.

Using the calculated adjustment, an operator can manipulate the control unit 29 to make said adjustment to the combination of the formulation in mixing chamber 9 by closing valve 21, belonging to vessel 5, and opening valve 23, belonging to vessel 7. The adjustment is made by effectively replacing the liquefied orange extract A with liquefied orange extract B. Of course, in other embodiments, a component may not be entirely replaced; instead the amount supplied of a particular component may change. Optionally, the adjustment may be made automatically in that updated control parameters to modify the beverage component ratio input to the mixing chamber 9 are sent to the control unit 29. The control unit 29 may then send control signals to valves 19, 21 and 23 to adjust the flow of components to incorporate orange extract B from vessel 7.

Following said adjustments, a blend of the carbonated orange drink from sweetened carbonated water and liquefied orange extract B may be extracted from the mixing chamber 9 by way of the outlet 35.

Referring back to FIG. 2, the memory resources, typically RAM 46 and HDD 68 comprise information on the various components of the beverage; in the present example, these components include: component i (sweetened carbonated water) having component attribute A, component j (liquefied orange extract A) having component attribute B, and component k (liquefied orange extract B) having component attribute C. These memory resources of the produced beverage, i.e the customer preferences, also contain the system constraints in terms of quality constraints including taste attributes, and operational constraints including minimum supplier purchases, load-out constraints, end-supply requirements, blending constraints, pasteurizing capacity and safety stock limit.

The memory resources also store computer elements, typically in the form of instructions and parameters, for configuring data processing apparatus 28 to retrieve data from database 27, process the data to deduce the ratios of beverage components to mix in the mixing chamber 9, and also to receive real-time attribute data from the system 1 to utilise in deducing the ratios of beverage components for achieving the target attribute profile of the blended beverage. Among the computer program elements there is included an optimisation module, an input interface template and output interface template module.

The overall process flow of a system regulating the formulation of a multi-component beverage attribute profile implementing an embodiment of the present invention will now be described with reference to FIG. 3.

The overall process begins with the preference information 80 initially providing sensory research 80a and volume forecast data 80a on the beverage to be produced. An analysis is made of the volume 81 and attribute requirements 82 of the beverage components depending on volume and attribute availability. The components—orange extract and water are allocated in desired quantities 83. For example, if the resource of an orange extract was limited in terms of availability, it may be prudent to allocate the limited resource to a particular market to achieve the optimal scenario. This may, for example, involve allocating to a particular market or production region to maximise quality of product or overall profits. An optimisation and blend plan is formulated 84. The beverage is blended, adjusted if necessary, stored and transported 85, which results in a final beverage product 86 issued to the consumer.

Referring to FIG. 4, there is illustrated a flow diagram of the optimisation procedure implemented by the data processing apparatus 28 in accordance with an embodiment of the present invention.

At step 500, a user uploads acquired component attribute information/data and input optimisation plan parameters into the system; for example by manually inputting it. The data is saved into a database 505 which may be implemented on HDD 68 or a remote memory store as shown at step 503. Visual Basic Application (VBA) modules validate the user's input data against validation criteria set in the VBA modules. An example of an input interface display screen is shown in FIG. 5. The input interface provides data input fields for the quality bounds of the taste factors including Brix, Acid ratio and orange extract concentration amongst others. The Quantity of different orange extracts is also indicated in respective fields.

The component or ratio bounds are also controlled from this input display. The user can adjust the ratio of blending components in order to control taste or to meet operational and/or supply constraints inherent in supplying each blend component. For example, one blend component may need to be used in a specific time period. Therefore, the user can control the specific component usage rate to satisfy the operational constraint while meeting taste targets. The quantity of available orange extract A and B required at a particular time is also indicated in respective fields. This requirement ensures an appropriate amount of safety stock is available to meet taste and supply targets. Additionally, this interface provides the ability to input the start and end date of the analysis period, as well as record comments and track previously executed blend plans over time (Plan ID and Revision ID).

The VBA modules run an optimisation sequence at step 507 by accessing the information in the database 505. The optimisation sequence may be implemented using any suitable optimisation routine such as such as the interior point methods (see FIGS. 7 and 8 for more detail). For example, the system of linear equations can be solved using Cplex optimizing software available from International Business Machines Inc™, Armonk, N.Y. A range of possible solutions can be produced. The possible solutions represent the blend plans that define the inputs to use, resources to use and products to be made. The routine generates output optimisation blend parameters at step 509. The generated parameters are relayed back to the database 505. The VBA modules read the data from the database and then display this information on an output display screen as indicated at step 511. An example of the output display screen is illustrated in FIG. 6, which shows the associated costs which each of the formulations of different component ratios having their corresponding attribute values.

From this display of optimised blend parameters, a user may select a desired beverage blend for a given period. The quantity, or ratio, of each beverage component, for each time period, is the optimal beverage blend plan which represents the user defined target attribute taste profile. These quantities are used to generate purchase decisions and implement the blend plan to meet consumer demand. The parameters for the selected beverage blend plan may be input automatically to the control unit 29 or manually input.

The database 500 is also continuously monitored, at step 513. When the database monitor detects a newly uploaded optimisation plan, it automatically initiates the optimisation sequence at step 507 so as to generate new optimisation blend parameters at step 509. Hence, for example, if the optimisation plan parameters change in that the availability of a particular component becomes scarce, this information will be saved to the database 505, and the new optimisation parameters may then be calculated on that basis. From the updated optimisation parameters, the user or operator may adjust the control unit 29 settings so as to produce a beverage in accordance with the new optimised blend parameters, and/or the new parameters may automatically be input to the control unit 29.

Referring now to FIGS. 7 and 8, there is depicted a two dimensional linear integer program and a graphical representation of an interior point method model, respectively. More particularly, FIG. 7 shows the parent relaxed problem and the first two sub-problems from branching on variable X(i).

The objective function 801 and constraints 803 combine to form a math program. The solution method optimizes the objective function subject to the constraints 803. In this embodiment, a branch and bound algorithm is used to solve the math program. The integer requirements are relaxed and the math program is solved as a continuous variable problem. This relaxed problem can be solved using an interior point algorithm, or a gradient descent algorithm. A variable is selected to ‘branch’ on based on the partial derivative of the objective function, projected onto the constraint surface, with respect to the variable. Along one branch the branching variable is constrained to be less than or equal to the next lowest integer value 805, while along the other branch the branching variable is constrained to be greater than or equal to the next highest value (see FIG. 7). The resulting sub-problems are solved until an optimal solution 807 is found that obeys all constraints and integrality requirements.

As can be seen from FIG. 8, the optimal feasible solution 807 is that point which is within the bounds but maximizes the objective function 801. Although, the integer point 805 to the bottom right of the optimal integer point 807 may provide greater attribute function in some respects, this integer point 805 falls outside the constraint 803 bounds set and thus cannot be considered the optimal solution 807.

In other embodiments, a branch and cut algorithm may be used, and branch and bound and branch and cut can be used in combination.

It is to be understood that any feature described in relation to any one embodiment may be used alone, or in combination with other features described, and may also be used in combination with one or more features of any other of the embodiments, or in combination of any of the embodiments.

Insofar as embodiments of the invention described are implementable, at least in part, using a software-controlled programmable processing device such as a general purpose processor or special-purposes processor, digital signal processor, microprocessor, or other processing device, data processing apparatus or computer system it will be appreciated that a computer program for configuring a programmable device, apparatus or system to implement the foregoing described methods, apparatus and system to implement the foregoing described methods, apparatus and system is envisaged as an aspect of the present invention. The computer program may be embodied as any suitable type of code, such as a source code, object code, compiled code, interpreted code, executable code, static code, dynamic code, and the like. The instructions may be implemented using any suitable high-level, low-level, object-oriented, visual, compiled and/or interpreted programming language, such as C, C++, Java, BASIC, Perl, Matlab, Pascal, Visual BASIC, JAVA, Active X, assembly language, machine code, and so forth. A skilled person would readily understand the term “computer” in its most general sense encompasses programmable devices such as referred to above, and data processing apparatus and computer systems.

Suitably, the computer program is stored on a carrier medium in machine readable form, for example the carrier medium may comprise memory, removable or non-removable media, erasable or non-erasable media, writable or re-writable media, digital or analogue media, hard disk, floppy disk. Compact Disk Read Only Memory (CD-ROM), Compact Disk Recordable (CD-R), Compact Disk Rewritable (CD-RW), optical disk, magnetic media, magneto-optical media, removable memory cards or disks, various types of Digital Versatile Disk (DVD) subscriber identify module, tape, and cassette solid-state memory. The computer program may be supplied from a remote source embodied in the communications medium such as an electronic signal, radio frequency carrier wave or optical carrier waves. Such carrier media are also envisaged aspects of the present invention.

As used herein, the terms “comprises”, “comprising”, “includes”, “including”, “has”, “having” or any other variation thereof, are intended to cover a non-exclusive inclusion. For example, a process, method, article, or apparatus that comprises a list of elements is not necessarily listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the invention. This is done merely for convenience and to give a general sense of the invention. This description should be read to include one or at least one and the singular also includes the plural unless it is obvious that it is meant otherwise.

The scope of the present disclosure includes any novel feature or combination of features disclosed therein either explicitly or implicitly or any generalisation thereof irrespective of whether or not it relates to the claimed invention or mitigate against any or all of the problems addressed by the present invention. The applicant hereby gives notice that new claims may be formulated to such features during prosecution of this application or any such further application derived therefrom. In particular, with reference to the appended claims, feature from dependent claims may be combined with those of the independent claims and features from respective independent claims may be combined in any appropriate manner and not merely in specific combinations enumerated in the claims.

1. A method of producing a multi-component beverage comprising a beverage attribute profile, the method comprising providing a first and second component of the beverage, each component having a component attribute profile; supplying to a beverage formulation zone the first component and the second component in a desired ratio and mixing the first and second components together to provide the beverage or a precursor thereof to yield a target beverage attribute profile; responsive to a change or predicted change in at least one component attribute profile, supplying information concerning the attribute change to a data processing apparatus and calculating with respect to that change an adjustment in the ratio to reduce the deviation of one or more attributes of the beverage attribute profile from the target beverage attribute profile.

2. The method of claim 1, further comprising storing said information in a database and supplying said information to said data processing apparatus from said database.

3. The method of claim 1 or 2, further comprising monitoring the attribute profile of each of the first and second components.

4. The method of any of claims 1 to 3, further comprising monitoring the beverage attribute profile and responsive to a change or predicted change in an attribute of said beverage attribute profile supplying further information concerning said change to said data processing apparatus for use in calculating said adjustment.

5. The method of any of claims 1 to 4, wherein the first and second components reside in separate vessels before being mixed.

6. The method of claim 5, wherein the vessels include valves for allowing controlled passage of the components to the beverage formulation zone.

7. The method of any of claims 1 to 6, wherein the at least one component attribute profile is selected from the cost of freight and storage of a particular component, cost of a particular component, quality of a particular component, consumer demand of a particular component, available supply of a particular component, and cost of processing/blending.

8. The method of any of claims 1 to 7, wherein the beverage is selected from a whole-grain nutritional beverage, high fructose sports drink, flavoured tea, flavoured coffee, caffeine-based drink, a carbonated soft drink, a-nut based drink, a dairy-based drink, mango juice, strawberry juice, vegetable juice, berry juice, alcoholic beverage, wine, tequila drink, vodka drink, rum drink, and kvass.

9. The method of claim 8, wherein the at least one component attribute profile is selected from the brix level of the beverage, flavour concentrations of the beverage, acid concentration of the beverage, colour of the beverage, taste of the beverage, texture of the beverage, amount of carbonated water content, and the level of carbonation of the water of the beverage.

10. The method of any of claims 1 to 9, wherein the method is a computer implemented method and the calculating step executed by a data processor.

11. A system for producing a multi-component beverage comprising a beverage attribute profile, the system comprising means for storing a first and second component of the beverage, a beverage formulation zone for mixing the first and second component of the beverage in a desired ratio effective to yield a target beverage attribute profile, the first and second component each having a component attribute profile, wherein the system comprises a data processing apparatus operable to receive information concerning a change or predicted change in at least one component attribute profile and, in response thereto, is operable to calculate with respect to that change an adjustment in the ratio to reduce the deviation of one or more attributes of the beverage attribute profile from the target beverage attribute profile.

12. The system of claim 11, wherein an attribute of at least one component of the beverage fluctuates over time.

13. The system of claim 11 or claim 12, further comprising means for adjusting the beverage ratio.

14. The system of any of claims 11 to 13, wherein the means for storing the first and second components comprises separate vessels.

15. The system of any of claims 11 to 14, wherein the formulation zone comprises a mixing chamber.

16. The system of any of claims 11 to 15, further comprising a database for storing said information.

17. The system of any of claims 11 to 16, further comprising at least one monitoring device for monitoring the attribute profile of each of the first and second components.

18. Use of the system according to any of claims 11 to 17 in regulating a multi-component beverage attribute profile.

19. A computer program comprising computer program elements operative in data processing apparatus to implement the method of any of claims 1 to 10 or system of any of claims 11 to 18.

20. A computer implementable method of modelling the production of a multi-component beverage comprising: representing said multi-component beverage by data values indicative of a physical attribute profile of said multi-component beverage; representing first and second components of said multi-component beverage by data values indicative of respective physical attributes of said first and second components; and deriving a combinatorial relationship between respective data values of said physical attributes of said first and second component to yield a combined attribute profile within predetermined limits of data values of said multi-component beverage attribute profile.

21. A method according to claim 20, wherein said constraint comprises a further data value or range of data values representative of an available amount of said first and/or second component.

22. A method according claim 20 or claim 21, wherein said constraint comprises a yet further data value or range of data values representative of an amount of multi-component beverage to be produced.

23. A method according to any of claims 20 to 22, wherein said combinational relationship comprises a ratio of said first component to said second component.

24. A method according to any of claims 20 to 23, further comprising providing control parameters derived from said combined attribute profile to a multi-component production system for controlling the supply of said first and second component to a formulation zone in amounts corresponding to said combinatorial relationship for mixing to form said multi-component beverage.

25. A computer program comprising computer program elements operative in data processing apparatus to implement the method of any of claims 20 to 24.
